(19) United States
(12) Patent Application Publication
(10) Pub. No.: US 2002/0198614 A1
(43) Pub. Date: Dec. 26, 2002

(54) Audio signal enhancement system

(76) Inventor: Ronald L. Sutherland, Lawrence, KS (US)

Correspondence Address: HARSHAW RESEARCH INCORPORATED, P O BOX 418, OTTAWA, KS, 66067, US

(21) Appl. No.: 09/891,959

(22) Filed: Jun. 26, 2001

(51) Int. Cl. G06F 17/00

(52) U.S. Cl. 700/94

(57) ABSTRACT

An audio signal enhancement system having a digital interface for transmitting a digital audio signal obtained from a digital storage device. The system includes a digital-to-analog converter connected to the digital interface for receiving the digital audio signal and converting it to an analog signal. An analog gain stage is connected to the digital-to-analog converter which includes at least one vacuum tube through which the analog signal is passed, whereby to amplify the analog signal and to impart enhanced euphonic characteristics to the analog signal.

### BACKGROUND OF THE INVENTION

This invention relates generally to audio signal playback systems and, more particularly, to a system which converts a stored digital audio signal to an analog signal and immediately passes said analog signal through a gain stage for audio signal euphonic enhancement.

Music stored in digital files on personal computers is becoming increasingly common and popular. The growing popularity of this storage medium has resulted from factors such as advanced data compression algorithms, cheaper storage media, faster computers that can stream music while performing other tasks, broadband Internet connections that permit fast access and sharing of music files, improved file management software, and “web casting” of music previously limited by the ability to receive radio signals. Therefore, the present and future trend is for music to be stored digitally on computers rather than just on records, tapes, or compact disks.

Audio hardware provided with or available for personal computers produces a playback quality that is unacceptable to critical music listeners. This low sound quality is due in part to the internal sound cards and speakers utilized in personal computer systems. Efforts to upgrade the sound quality of digital audio files stored on a computer include better speakers connected to the computer, sound cards having line-level outputs driving external amplifiers and speakers, and external digital-to-analog converters with or without built-in power amplifiers.

All digitally stored audio signals are converted to analog signals prior to being output through a speaker. The stored digital data representing the original musical event is an approximation of the original analog information. It is obtained by periodically sampling the information and each sample is of limited resolution. Although digital storage of information has many advantages, the texture and smooth continuity of the music is compromised in the conversion. To bring the music to life, it is necessary to enhance and restore the musicality damaged by the digitization process. Because solid-state devices and vacuum tubes have inherently different transfer characteristics for the same input signal, each type of amplifier has a different output signal. For the critical listener, the output from a vacuum tube stage more closely approximates the original musical event.

Therefore, it is desirable to have an audio signal enhancement system that converts digital audio signals, such as music files digitally stored on a computer, to an analog signal in a manner that is musically satisfying to the critical listener. Further, it is desirable to have a system which adds desirable even-order harmonics to the analog signal immediately following conversion such that later amplifications are of the enhanced signal.

### SUMMARY OF THE INVENTION

An analog signal enhancement system according to the present invention includes a digital interface connection along which a digital signal may be communicated. The system includes a digital-to-analog converter for converting the transmitted digital signal into an analog signal. A vacuum tube analog gain stage is directly connected to the digital-to-analog converter such that the converted signal is immediately passed through the vacuum tube gain stage prior to any further amplification. A digital signal processor precedes signal conversion for increasing the number of data values representing the audio reproduction through interpolation. Each audio channel represented by the audio signal is associated with a digital-to-analog converter and vacuum tube gain stage. Separating the channels of an audio signal is conventional according to an established protocol of audio signal transmission. As the audio signal is passed through respective vacuum tubes, certain euphonic characteristics are inherently imparted thereto, such as the addition of even-order harmonic frequencies, limitation of non-music frequencies (“noise”), etc.

To the critical music listener or “musical purist”, it is crucial that a digitally stored audio signal retrieved from a computer hard disk drive or from a local area network, etc. be enhanced through a vacuum tube analog gain stage before otherwise being amplified by amplifiers. The digital signal, in essence, needs to be repaired before it is amplified. Just as enlarging a flawed photograph merely amplifies the flaws, amplifying a “flawed” audio signal only amplifies the flaws. The musical purist desires to have the coloration that results from passage of an analog signal through vacuum tubes applied to the audio signal at the earliest possible stage such that downstream amplification will be of a good signal. Another reason to apply this technology at an early stage is that manipulating a signal having a small amplitude and power requirement is less expensive, requires less power, and is less demanding on the hardware components.

Although various devices have been proposed in the art which use vacuum tubes in the amplification stage of audio output, existing devices do not provide vacuum tube enhancement of an analog signal immediately upon conversion from a signal digitally stored upon a personal computer storage media or received from a computer network server or other similar storage media.

Therefore, a general object of this invention is to provide a system which restores and enhances the euphonic characteristics of a digitally stored audio signal immediately following conversion of the digital signal to an analog signal.

Another object of this invention is to provide a system, as aforesaid, which adds even-order harmonics to an audio signal prior to any amplification thereof which tends to add odd-order harmonics to the signal.

Still another object of this invention is to provide a system, as aforesaid, which limits or eliminates frequencies from the analog signal that are indicative of noise or interference.

Other objects and advantages of this invention will become apparent from the following description taken in connection with the accompanying drawings, wherein is set forth by way of illustration and example, embodiments of this invention.

### BRIEF DESCRIPTION OF THE DRAWINGS

FIG. 1 is a block diagram of an analog signal enhancement system according to the preferred embodiment of the present invention; and

FIG. 2 is a block diagram of another embodiment of the present invention.

### DESCRIPTION OF THE PREFERRED EMBODIMENT

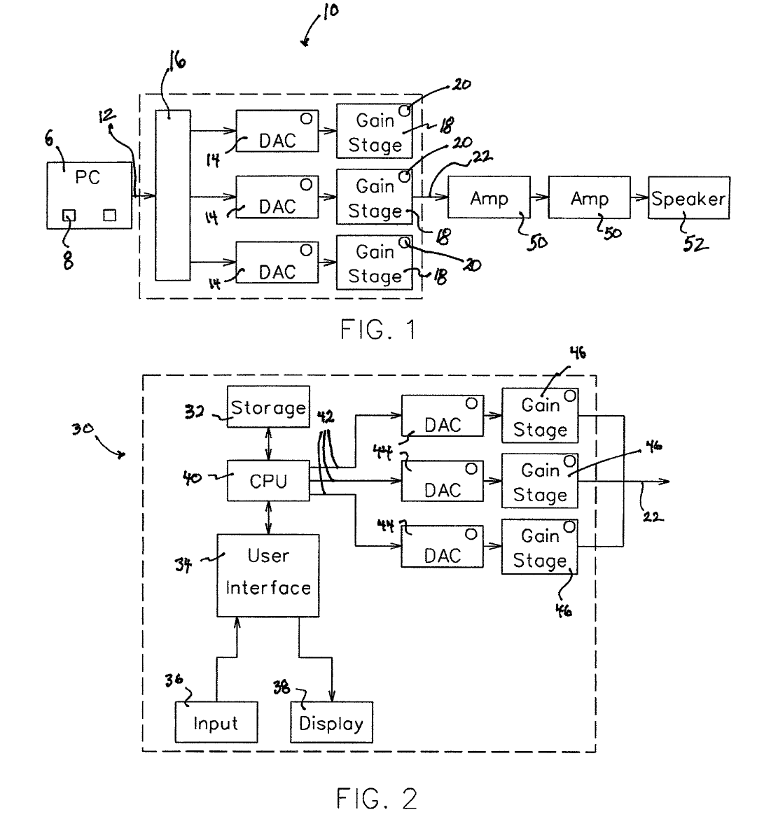

An analog signal enhancement system 10 according to a preferred embodiment of the present invention will now be described with reference to FIGS. 1 and 2 of the accompanying drawings.

The analog signal enhancement system 10 includes a digital interface 12 along which a digital signal may be communicated (FIG. 1). The digital interface 12 may be any data transfer medium capable of transmitting a digital signal. Preferably, the digital interface is a universal serial bus (“USB”) connected to a hard disk drive 8 of a personal computer 6. However, the digital interface 12 may also be a local area network (“LAN”) cable connected to a computer network server or even a transmitter/receiver combination for the remote transmission of digital signals from a digital storage medium. It is understood that the digital interface may also include a computer chip adapted to receive the data from the means described above.

The system 10 further includes at least one digital-to-analog converter 14 (“DAC”) connected to the digital interface 12 for receiving a digital signal transmitted along the interface. The system 10 may include a plurality of DAC's as one DAC is needed for each audio channel represented by the digital audio signal. It is understood that a digital signal representing a signal that is “in stereo” includes two channels and so a system according to the present invention would have two DAC's—one for each channel. Similarly, a digital signal recorded for “surround sound” playback includes a plurality of channels and so a system according to the present invention would include a respective plurality of DAC's. Separating the channels of a digital signal and directing them to respective DAC's for conversion is accomplished according to a conventional protocol by a digital signal processor 16, as further described below.

The digital signal processor 16 receives an incoming digital audio signal from the digital interface 12 for processing said signal prior to conversion to an analog signal (FIG. 1).

The processor 16 is capable of inserting appropriate additional data values between existing data values of the incoming digital signal using a mathematical interpolation algorithm. This has the effect of making smoother transitions between data values and therefore a smoother analog signal that is more pleasing to listen to.

The system 10 includes at least one vacuum tube analog gain stage 18 with one gain stage being electrically connected to each DAC 14. Each gain stage 18 includes a vacuum tube 20 (FIG. 1) through which an incoming analog signal from a respective DAC 14 is passed. Upon passage through the vacuum tube 20, the analog signal is amplified sufficiently to drive the signal downstream through an output channel 22. Passage through the tube also imparts enhanced euphonic characteristics to the signal. One enhanced euphonic characteristic imparted to the analog signal is distortion of the signal to include even-order harmonics, it being understood that even-order harmonics are more pleasing to listen to than odd-order harmonics. Solid-state audio components tend to impart more odd-order harmonic frequencies than vacuum tubes. For example, an analog signal having a frequency of 1 kHz may be distorted upon passage through a vacuum tube 20 to include even-order frequencies such as 2 kHz, 4 kHz, 8 kHz, etc. These frequency distortions provide a more ear-pleasing coloration of the sound than odd-order frequency distortions such as 3 kHz, 5 kHz, 7 kHz, etc.

Another euphonic enhancement of the analog signal caused by passage through a vacuum tube is low-pass filtering and, more particularly, the limitation of frequencies of the analog signal that are below a predetermined frequency. This limitation of frequencies from the signal eliminates the “noise” of signal interference and thus yields a more audibly pleasing sound.

In operation, the analog signal enhancement system 10 may be connected to a source of digital audio files using an appropriate digital interface 12, such as a USB or LAN connection. As a digital signal is transmitted along the digital interface, it may be directed to one or more DAC's 14 depending on the number of channels represented thereby. Before a digital signal is received by a DAC 14, some signal pre-processing is undertaken to “smooth out” the signal by inserting additional data values through interpolation. Then the DAC 14 converts the digital signal to an analog signal. The analog signal is immediately received by a respective vacuum tube analog gain stage 20, whereby the analog signal is amplified sufficiently to move the signal downstream and is euphonically enhanced. The enhanced analog signal is thereby driven downstream along an output channel 22 where it may be further amplified with external amplification components 50 and ultimately audibly output through a speaker 52 (FIG. 1).

Accordingly, the present system 10 provides a euphonic enhancement of an audio signal at the earliest possible stage of an output or playback sequence, thus ensuring the highest quality analog signal at each subsequent stage of amplification. Therefore, a properly colored analog signal that has restored and enhanced the musicality lost in the digitization process is available to be utilized by later amplification stages rather than just amplifying a signal that is unacceptable to the audio purist. It is better to amplify a good signal than a bad one in the same way that it is better to enlarge a good photograph than a bad one. In addition, initiation of early signal enhancement consumes less power and is less demanding on the electronic components.

Alternatively, an analog signal enhancement system 30 according to another embodiment of the invention may include its own digital storage device 32 and a user interface 34 (FIG. 2). Preferably, the digital storage device 32 is a hard disk capable of storing a plurality of digital audio records. The user interface 34 includes an input means 36, such as buttons or a keyboard, and a display 38 (FIG. 2). Under the control of a central processing unit 40, a user may select a desired audio digital record and the CPU 40 will cause that record to be transmitted to a DAC 44 along a digital interface 42. The DAC 44 and gain stage 46 shown in FIG. 2 are arranged and operate in substantially the same manner as described previously. This embodiment, therefore, may operate as a music jukebox having digital audio files stored therein and produce an enhanced analog signal for playback.

It is understood that while certain forms of this invention have been illustrated and described, it is not limited thereto except insofar as such limitations are included in the following claims and allowable functional equivalents thereof.

Having thus described the invention, what is claimed as new and desired to be secured by Letters Patent is as follows:

1. An audio signal enhancement system capable of receiving a digital audio signal from a digital storage device for enhancing said digital audio signal during amplification thereof, said audio signal enhancement system comprising:
a digital interface connected to said digital storage device adapted to communicate a digital audio signal;
a digital-to-analog converter electrically connected to said digital interface for receiving said digital audio signal and converting said digital audio signal into an analog signal having a low amplitude;
an analog gain stage electrically connected to said digital-to-analog converter and having at least one vacuum tube, said analog signal being changed into an amplified analog signal having enhanced euphonic characteristics when said analog signal is passed through said at least one vacuum tube;
at least one audio output for electrically communicating said strengthened analog signal.

2. The system as in claim 1 wherein said digital interface is a universal serial bus.

3. The system as in claim 1 wherein said digital interface is a local area network.

4. The system as in claim 1 wherein said digital interface is a transmitter/receiver combination capable of transmitting said digital audio signal from said digital storage device to said digital-to-analog converter.

5. The system as in claim 1 wherein said digital audio signal represents at least one channel of analog output.

6. The system as in claim 1 wherein said enhanced euphonic characteristics include distortions of said analog signal having even-order harmonic frequencies.

7. The system as in claim 1 wherein said enhanced euphonic characteristics include limitations of frequencies of said analog signal below a predetermined frequency, whereby to eliminate noise caused by electronic interference.

8. The system as in claim 1 further comprising digital signal processing means intermediate said digital interface and said digital-to-analog converter for adding additional data values to said digital analog signal through interpolation of existing data values thereof.

9. An audio signal playback and enhancement system, comprising:
a digital storage device adapted to store a plurality of digital audio records;
a user interface for selecting a digital audio record from said plurality of digital audio records;
a digital interface connected to said digital storage device and adapted to transmit a selected digital audio record therealong;
a digital-to-analog converter connected to said digital interface for receiving said selected digital audio record and converting said digital audio record into an analog signal;
an analog gain stage connected to said digital-to-analog converter and having at least one vacuum tube through which said analog signal is passed, said analog signal being converted into an amplified analog signal having enhanced euphonic characteristics upon passage through said at least one vacuum tube; and
at least one audio output for communicating said strengthened analog signal.

10. The system as in claim 9 wherein said user interface comprises:
a central processing unit (“CPU”);
a display connected to said CPU for displaying a plurality of identifiers associated with respective digital audio records; and
means for selecting an identifier associated with a desired digital audio record.

11. The system as in claim 9 wherein said digital interface is a universal serial bus.

12. The system as in claim 9 wherein each digital audio record defines a corresponding digital audio signal representing at least one channel analog output.

13. The system as in claim 9 wherein said digital storage device is a hard disk drive.

14. The system as in claim 9 wherein said digital storage device is a computer network server.

15. The system as in claim 9 wherein said enhanced euphonic characteristics include distortion of said analog signal to include even-order harmonic frequencies.

16. The system as in claim 9 wherein said enhanced euphonic characteristics include limitation of frequencies of said analog signal below a predetermined frequency, whereby to eliminate noise caused by electronic interference.

17. The system as in claim 9 further comprising digital signal processing means intermediate said digital interface and said digital-to-analog converter for adding additional data elements to said digital analog signal through interpolation of existing data elements thereof.
